(19) United States
(12) Patent Application Publication
(10) Pub. No.: US 2005/0058750 A1
(43) Pub. Date: Mar. 17, 2005

(54) Food additive

(76) Inventor: Wolfgang Kempe, Dresden (DE)

Correspondence Address: Richard M. Rosati, Esq.;KENYON & KENYON, One Broadway, New York, NY, 10004, US

(21) Appl. No.: 10/660,909

(22) Filed: Sep. 12, 2003

(51) Int. Cl. A23B 4/00

(52) U.S. Cl. 426/309

(57) ABSTRACT

Food additives for both human and animal feeding including a favorable form of administration for lecithin and/or a lecithin derivative with its advantageous therapeutic effects on human and animal organisms. To that end, the food additive includes a coating including lecithin and/or a lecithin derivative formed on a plant natural product having a spherically curved surface. Within the coating, further components such as, for example, vitamins, flavoring agents, trace elements, pharmaceutical agents and pharmaceutically effective components, can also be included along with the lecithin and/or lecithin derivative.

### FIELD OF THE INVENTION

The invention relates to a food additive for human feeding and animal feeding as well. Specifically, the invention is directed to an appropriate form of administration for lecithin having its admittedly advantageous therapeutic effect to human and animal organisms.

### BACKGROUND OF THE INVENTION

Thus far, lecithin is usually manufactured and distributed in a liquid, highly viscous form as a granule or in capsules in which the lecithin is included in a dissolving protective covering.

Lecithin salvaged from plant or animal primary products has a fatty and sticky consistency, as a rule, such that it is typically administered either in a liquid form or a capsule form as already mentioned. In contrast, there is considerable manufacturing cost for the lecithin granule since liquid components have to be largely removed by means of intensive drying.

In addition, the granules thus fabricated are not particularly suited for the oral ingestion of food since deficits are to be noted as regards the taste as well as the instinct with chewing the granules. In particular, with chewing, the desired crunchy effect is generally missing.

### SUMMARY OF THE INVENTION

Thus, it is an object of the invention to provide a food additive including lecithin for both human and veterinary application which can be favorably manufactured and which possesses advantageous properties with regard to oral ingestion.

### DETAILED DESCRIPTION

According to an embodiment of the food additive of the invention, which is fabricated and allowed to be administered in a granulate form, a coating comprising lecithin is formed on a plant natural product having a spherical surface. However, according to another embodiment of the food additive of the invention, the coating can also include a lecithin derivative alone, or in addition to the lecithin. For example, a suitable lecithin derivative is phosphatidyl serine.

Preferably, the lecithin is present in the coating in an amount greater than about 50 percent by weight, and more preferably, at least about 70 percent by weight.

A lecithin derivative is also allowed to be included in the coating at lower amounts than lecithin in order to be able to take advantage of the physiologically advantageous effects thereof. Thus, in an embodiment of the coating, just a few milligrams (mg) of lecithin may be sufficient.

Particularly appropriate plant products which have a suitable spherical surface include various seeds which can be used without any chemical and/or thermal pretreatment, and which can be provided with a coating including the lecithin.

With some of such plant seeds, such as poppy seed for example, any mechanical pretreatment can be abandoned, and accordingly the coating including the lecithin can be deposited immediately on the merely cleaned surface of the poppy seeds.

However, other types of seeds, such as for example, mustard, rape or flax seeds, are also suitable for use in the present invention.

If millet seeds are used as a plant natural product in accordance with the present invention, the millet seeds should be relieved from its shells. However, the seeds should generally remain in their natural state.

As a result of the inherent available properties of the lecithin, it is not required to use additional bindings for the formation of the coating.

However, for the formation of the coating the emulsifying properties of lecithin can be advantageously used since with the fabrication of the coatings on the spherically curved surfaces of the plant natural products the viscosity can not only be reduced exclusively by means of organic solvents, but also with the respective addition of water, and accordingly the manufacturing costs and the safety effort required during the production are allowed to be correspondingly reduced.

However, further favorable additives which are appropriate for metabolism and therapeutic effects, respectively, can be included within the coating largely formed from lecithin.

Thus, vitamins, flavoring agents (such as, e.g., tea, green tea, vanilla), trace elements (such as, e.g., Fe or Ca), pharmacologically and/or therapeutically effective matters or such components of matter can also be included within the coating.

Of course, dyes can also be used.

However, the additional matters or components of matter are allowed to be used in natural as well as synthetic forms.

According to another embodiment of the invention, the coating is also allowed to have been formed from a plurality of layers similar to the skins of an onion. The layers are allowed each to be formed from different components such as those which have been mentioned further above. However, individual layers or the entire coating are also allowed to have been formed from mixtures of components.

According to another embodiment of the invention, for the consumption, storage and during transportation as well it is advantageous to form a protective layer on the coating. Such protective layers can be formed film-like, preferably as a physiologically and toxicologically harmless wax. Thus, a protective layer can be formed from carnauba wax, for example. However, the protective layers can also be formed from cellulose methyl ether or a sugar or sugar-like matter (e.g., polysaccharides or oligosaccharides). A film layer can be formed by spraying, for example. Preferably, with the coating methods and devices which are known in the art, the coatings of the present invention (preferably, largely formed from lecithin, and in which additional matters and components can also be included) are allowed to be formed with a uniform and constant layer thickness onto the spherically curved surfaces of the plant natural products employed.

The food additive according to the invention in the granulate form can be readily eaten orally.

However, it is also possible for the food additive according to the invention to be added to a yogurt or another milk product immediately before the consumption of such other food or to be used as a component of a muesli mixture.

During the consumption thereof, the crunchy consistency of the plant natural products carrying the coatings has an agreeable effect on the feeling of the consumer.

In particular, the plant natural products in the form of seeds used for the food additive according to the invention reduce the manufacturing cost, contribute to the digestion as roughage due to its high proportion of fibers, and enable a defined formation of a coating since diffusing and infiltrating of matters forming the coating cannot occur. In that regard, the mass of the coating and accordingly the mass of lecithin as well, is generally greater than the mass of the plant natural product.

Thus, it is also possible for the food additive according to the invention to include a mixture of coatings having the same or different consistency and/or a mixture of different plant natural products provided in coatings which are then allowed to have different outer diameters correspondingly.

However, in another embodiment of the invention, it is also possible to provide the food additive in a granulate form of almost equal sizes (i.e., a very narrow uniform range of seed sizes has been kept).

1. A food additive in a granulate form, the food additive comprising:
a plant natural product having a spherical surface; and
a coating on the plant natural product, the coating comprising at least one of lecithin and a lecithin derivative.

2. The food additive according to claim 1, wherein the lecithin is present in an amount greater than about 50 percent by weight of the coating.

3. The food additive according to claim 2, wherein the lecithin is present in an amount of at least about 70 percent by weight of the coating.

4. The food additive according to claim 1, wherein the plant natural product comprises a seed.

5. The food additive according to claim 2, wherein the plant natural product comprises a seed.

6. The food additive according to claim 5, wherein the seed comprises a poppy seed, a rape seed, a flax seed, a mustard seed or a millet seed.

7. The food additive according to claim 1, wherein the lecithin derivative comprises phosphatidyl serine.

8. The food additive according to claim 1, wherein the coating further comprises at least one of a vitamin, a flavoring agent, a trace element, a pharmaceutical active substance and a pharmaceutical active components.

9. The food additive according to claim 1, wherein the coating further comprises a plurality of layers.

10. The food additive according to claim 1, wherein the coating has a constant layer thickness.

11. The food additive according to claim 1, further comprising a protective layer on the coating.

12. The food additive according to claim 11, wherein the protective layer comprises a film or a wax.

13. The food additive according to claim 1, wherein the weight of the coating is greater than the weight of the plant natural product.
